(19) United States
(12) Patent Application Publication
(10) Pub. No.: US 2019/0124934 A1
(43) Pub. Date: May 2, 2019

(54) SHELF-STABLE COMPOSITIONS AND METHODS OF THEIR MAKING

(71) Applicant: INTERNATIONAL DEHYDRATED FOODS, INC., Springfield, MO (US)

(72) Inventors: Roger L. DAKE, Springfield, MO (US); Stephanie LYNCH, Springfield, MO (US); Jack C. CAPPOZZO, Springfield, MO (US); Gary R. COPELAND, Granby, MO (US)

(21) Appl. No.: 16/171,574

(22) Filed: Oct. 26, 2018

Related U.S. Application Data
(60) Provisional application No. 62/578,156, filed on Oct. 27, 2017.

(51) Int. Cl. A22C 21/00; A23L 3/16; A23L 13/50

(52) U.S. Cl. CPC A22C 21/0061; A22C 21/0053; A23V 2250/542; A23L 13/55; A23V 2002/00; A23L 3/16

(57) ABSTRACT

Disclosed here are methods of preparing a shelf stable (aseptic) product suitable for storage and transportation by using an ultra-high temperature process. The product may be derived from poultry or other animal sources and has high percentages of solids and proteins.

### RELATED APPLICATION

This application claims priority to U.S. patent application Ser. No. 62/578,156 filed Oct. 27, 2017, the entire content of which is hereby incorporated by reference into this application.

### BACKGROUND

### 1. Field of the Invention

This disclosure relates to shelf-stable food products derived from animal sources and methods of preparing the same. More particularly, it relates to a process of making an aseptic liquid product in a package suitable for storage and transportation by using an ultra-high temperature process.

### 2. Description of Related Art

Animal (e.g., poultry) derived products provide various benefits for human health. Various ingredients prepared from poultry or other animals may be used to make a final food product. Examples of these ingredients may include but are not limited to dried chicken, rendered poultry meals, chicken broth and fats. These individual ingredients may be contaminated by Salmonella or other pathogens and microorganisms. Even if individual ingredient is free from contamination, the product may be contaminated during mixing, storage and transportation. Animal derived broth products are traditionally stored and transported in a frozen state. However, handling frozen products are not convenient and contamination may occur during the handling process. In addition, storing and transporting frozen broth is not energy efficient and not economical.

### SUMMARY

The present disclosure advances the art by providing methods to prepare products having high concentrations of solids (as well as proteins) and are stable at room temperature in sterile packaging.

In one embodiment, the disclosed process subjects a broth composition prepared from an animal source to a high temperature process for a short period of time, also called Ultra-High Temperature (UHT) processing and is packaged into a sterile container. In one embodiment, the resultant products are free or substantially free from pathogenic or spoilage microorganisms. In another embodiment, the resultant products contain high percentage of solids and do not support growth of pathogenic or spoilage microorganisms that breaks through and enter the otherwise sterile container.

In another embodiment, the starting material may be subject to (a) enzyme treatment or (b) membrane filtration without enzyme treatment before being subject to the disclosed high temperature process. In one aspect, the processes of (a) and/or (b) render the starting material pumpable. This pumpable starting material may be subject to the high temperature process disclosed herein. In another embodiment, the starting material is not pumpable, but the products obtained after the high temperature process are pumpable and may be readily filled into the container. The disclosed process may be used for items such as broth derived from poultry or other animal sources, as well as tomato sauce, gravies, sauces, puddings, vegetable purees, and other food products.

In another embodiment, methods to prepare a shelf stable composition derived from poultry or other animal sources are disclosed.

In one aspect, the composition is treated and packaged such that the product in the package is the equivalent of pasteurized product and is considered free from pathogenic or spoilage microorganisms, such as Salmonella. In another aspect, the disclosed process may allow direct addition of the packaged product into the processing stream without the need for additional treatment to ensure product safety.

In one embodiment, a process for making a shelf stable product derived from an animal or poultry source is disclosed, which may include the steps of (a) heating a starting material to a first temperature of between 90° C. and 205° C. and hold at said first temperature for a period of time between 1 and 120 seconds; (b) cooling said heated composition of step (a) to a second temperature of between 15° C. and 50° C.; and (c) filling said cooled composition of step (b) into a sterilized packaging container. In one aspect, the starting material may be heated to a first temperature of between 90° C. and 205° C. and held at the first temperature for a period of time between 1 and 120 seconds, between 15 and 120 seconds, between 30 and 120 seconds, or between 60 and 120 seconds, to kill vegetative bacteria and spores. In another aspect, the first temperature is between 110° C. and 175° C., or between 120° C. and 150° C. In one aspect, the starting material is heated to a first temperature of between 143° C. and 150° C. and hold at that temperature for about 10 seconds, 15 seconds, 20 seconds, 30 seconds, 60 seconds, 90 seconds, or about 120 seconds. In another embodiment, the starting material may be held at the first temperature for a period of time sufficient to kill spores of certain bacteria. The length of the time period to hold the composition at the first temperature may vary, which may be determined by the time required to kill specific microorganisms. Examples of such microorganisms may include but are not limited to Salmonella, E. coli or other pathogens of concern.

In one embodiment, the heated material may be cooled to a second temperature before being filled hot into bags, totes or other appropriate packaging or transportation containers, which may be sealed to prevent recontamination. The second temperature may be between 15° C. and 50° C., between 21° C. and 37° C., or between 25° C. and 37° C. In one aspect, the cooling is achieved by active cooling. In another aspect, the heated material may be cooled to a second temperature within 10 minutes, 2 minutes, or 1 minute.

In one embodiment, the disclosed process does not require addition of any extraneous carbohydrate or salt to generate the shelf-stable pumpable composition having high solids content.

In another embodiment, the total number of live pathogens (including spores) in the shelf stable composition obtained in step (c) is at least 2-fold, 3-fold, 5-fold, 10-fold, or 100-fold lower than the total number of live pathogen in the starting material in (a). In another embodiment, the total number of live pathogen in the disclosed shelf stable composition obtained in step (c) is at least 95%, 99%, or 99.9% lower than total number of live pathogen (including spores) in said starting material in step (a). In another embodiment, the disclosed process provides at least 10 log cycle, or at least 12 log cycle reduction of live pathogens (including spores) in the shelf stable composition obtained in step (c) as compared to the starting material. Examples of pathogens may include but are not limited to bacterium, fungus, virus or combination thereof. Examples of bacteria may include but are not limited to E. coli, Salmonella, Listeria, Clostridium botulinum, Campylobacter, Shigella, Yersinia, Arcobacter, Bacillus (e.g., Bacillus stearothermophilus), or combination thereof. In one aspect, the total number of Salmonella in the shelf stable composition obtained in (c) is at least 2-fold, 3-fold, 5-fold, 10-fold, or 100-fold lower than the total number of Salmonella in the starting material in (a).

In one embodiment, the starting material may have water activity that may support bacterial growth, for example, as high as 0.9, or 0.95 or higher. In another embodiment, after being subject to the disclosed process, the composition may become commercially sterile and is contained within the sterile environment of the container. In another embodiment, the disclosed compositions may have a water activity of 0.85 or lower, 0.83 or lower, 0.8 or lower, 0.7 or lower, 0.6 or lower, or 0.5 or lower. In one aspect, the low water activity may be achieved by allowing the free liquid to evaporate from the compositions. In another aspect, when the water activity of the disclosed composition is so low that it does not support bacterial growth, the packaged compositions of the present disclosure have a unique advantage in that even if there is an accidental puncture or other loss of package seal or integrity, the compositions inside the container does not support bacterial growth. In another embodiment, the composition prepared according to the disclosed process meets the regulatory criteria for commercially sterile product. In one aspect of the present disclosure, the process may include a step wherein the final product obtained in step (c) may be verified for food safety or certified by a qualified process authority.

In one embodiment, the ingredients may be prepared from an animal, such as poultry. Examples may include but are not limited to chicken, turkey, or other birds. In another embodiment, the ingredients may be prepared by using parts from other animal sources.

In one embodiment, the disclosed shelf-stable composition may be prepared from an animal source, and is germ-free. The composition may be packaged in a container with germ-free headspace for transportation and/or storage. In one aspect, the germ-free headspace may be at least 1 cubic centimeter (cm³), at least 10 cm³, at least 100 cm³, or at least 1000 cm³ by volume.

In another embodiment, the shelf-stable composition is in a liquid state in the container at room temperature (i.e., about 25° C.) under normal pressure. In another embodiment, the shelf-stable composition is not in a gel or solid state in the container at room temperature. In one aspect, the composition has a dynamic viscosity of less than about 25,000 cP, 10,000 cP, 5,000 cP, 1000 cP, 500 cP, 250 cP or lower at 25° C.

In one aspect, the disclosed shelf-stable composition comprises about 15% to 80% (w/w) solids, or about 20% to 80% (w/w) solids. In another aspect, the composition comprises at least 25%, at least 30%, at least 40%, at least 50%, or at least 70% (w/w) solids.

In another embodiment, the disclosed composition is shelf stable (i.e., free from germ) 6 months, 12 months, 24 months, 36 months or 48 months or longer after being filled into the container.

In another embodiment, the starting material may be a mixture of at least two ingredients: a first ingredient and a second ingredient, wherein the first ingredient is dried poultry or poultry meals, and the second ingredient is oil and/or fat derived from an animal or plant source.

In another embodiment, the disclosed compositions may comprise about 10-80% (w/w) protein and about 10-80% (w/w) fat. In another embodiment, the disclosed compositions may comprise about 20-80% (w/w) protein, at least 30% (w/w) proteins, at least 40% (w/w) proteins, or at least 50% (w/w) proteins.

In one embodiment, the disclosed compositions have low acidity. In one aspect, the disclosed compositions may have a pH of between 6 and 7, between 6.1 and 6.6, or between 6.2 and 6.5. In another embodiment, in addition to thermal process treatment, other factors, such as the percentage of solids, the water activity, and the pH of the composition, alone or together, may have certain effects on the shelf life of the disclosed composition.

Also disclosed is a system for storing or transporting a composition. In one aspect, the system may include a container and the shelf-stable composition disclosed herein. In another aspect, the shelf-stable composition is free from germ and contains about 20-80% (w/w) solids. In another aspect, the shelf-stable composition is in a liquid state and is pumpable during the entire period when it is in the container and kept at room temperature.

The compositions and systems disclosed herein may be characterized by the unique composition and components as described herein. The disclosed compositions may also be characterized by the methods by which they are prepared.

### DETAILED DESCRIPTION

Animal (e.g., poultry) derived products such as chicken soup or chicken broth provide various benefits to human health. In preparing a final product, different ingredients may sometimes be prepared at different locations and then mixed to make the final product. These different ingredients may also be transported to a different location to make the final products.

In one embodiment, transportation may occur before or after the mixing of the different ingredients. Examples of such ingredients may include but are not limited to dried chicken, rendered poultry meals, and fats, among others.

These various ingredients may be cooked sufficiently to kill Salmonella and other microorganisms. However, the materials may be re-contaminated during storage and shipping, especially when shipped in bulk in open top truck-trailers that are covered by a roll-over canvas and/or are emptied through non-aseptic means.

Poultry derived broth products are traditionally stored and transported in a frozen state. Partitioning and thawing a large frozen block is time consuming and may present safety hazards.

Disclosed here are methods to store and/or transport shelf stable ingredients derived from poultry or other animal sources at room or ambient temperature. In one embodiment, the ingredients may be packaged such that it remains as liquid during the entire time when it is in the packaging container. According to one embodiment of the disclosed methods, this streamlined process helps minimize introduction of Salmonella and other microorganisms of concern into the manufacturing environment, and allow direct addition of the ingredient into the processing stream without the need for additional treatment to ensure product safety. In addition, liquid product at room temperature is more convenient and safer to handle during storage or during transportation. Storing and transporting liquid products that are shelf-stable are also more energy efficient as compared to the traditional method.

In one embodiment, the color of the composition turns darker after being treated by the high temperature process. The change in color may be measured by conventional color-metric methods, for instance, by using an instrument called ColorFlex EZ manufactured by HunterLab. In one aspect, the pre-treatment broth composition has a color value that is a, as measured by ColorFlex EZ, and the post-treatment broth composition has a color value that is b, wherein b is smaller than a, and the difference between a and b is greater than 1, or 2.

As used herein, the term “animal” may include but are not limited to cattle, cow, pig, sheep, goat, poultry, fish, among others.

The term “container” may refer to standalone containers or bags for holding the mixture, as well as vessels that are mounted on a vehicle. Examples of containers may include but are not limited to totes, boxes, super sacks, bags, vessels, or combination thereof. In one aspect, the container is a closed container. In one embodiment of this disclosure, the container may have at least one heating means for maintaining the mixture at an elevated temperature, for example, at a temperature between 40° C. and 100° C., and more particularly, between 60° C. and 100° C. In another embodiment, the container may be placed in an environment in which the temperature is maintained between 40° C. and 100° C., and more particularly, between 60° C. and 100° C. In another embodiment of this disclosure, the container may comprise a means for reducing the number of pathogens in the mixture. By way of example, in one aspect of this disclosure, certain physical means (e.g., heating, radiation, lighting, etc.) for killing virus, bacteria, and/or fungus may be built into the container. In another aspect, the container may also contain a mechanism for mixing the ingredients during transportation.

The terms “broth” and “soup” refer to a liquid composition containing at least one solute and may also be used to refer to a ready to serve form, a concentrate, a stock in either liquid or solid form.

The term “shelf stable” or “shelf-stable” refers to a composition that may be safely stored at room temperature without being spoiled (i.e., germ-free) for an extended period of time, for example, for at least 10 days, 1-6 months, 12 months, or 24 months or longer. The terms “room temperature” and “ambient temperature” have the same meaning and both refer to temperature of 20-30° C., typically about 25° C.

The term “solids” as used herein refers to soluble components of a liquid composition that remain after all free liquid is removed (e.g., through evaporation) from the liquid composition. In the case of an aqueous broth, the free liquid is water. In certain embodiments, the disclosed composition may contain insoluble components in addition to the soluble “solids.” By way of example, these insoluble components may include small bits of solid proteins and/or fats added as flavorings.

The term “liquid” or “liquid state” refers to the physical state of a composition as a liquid, as the term would normally be construed by one of ordinary skill in the art. In one aspect, a liquid composition may contain up to about 10% (w/w) of insolubles. In another aspect, a liquid composition may contain less than 10%, less than 5%, less than 1%, or less than 0.1% (w/w) of insolubles. The term “pumpable” or “pourable” refers to the state of a composition having sufficient liquidity such that the composition may be poured by decanting or it may be passed through a pump without applying significant pressure. In one embodiment, the pumpable composition (e.g., broth) has a viscosity of 25,000 cP, 10,000 cP, 5,000 cP, 1000 cP, 500 cP, 250 cP or lower at 25 C. In one aspect, a liquid composition may contain up to about 10% (w/w) of insolubles but may remain pumpable.

The term “substantially free” means that the number of a certain subject is so low in a composition that it is negligible. For example, a food product that is substantially free from a pathogen means the amount of the pathogen (including its spores, if any) is so low that it is generally considered safe to consume by human.

### EXAMPLES

The following examples are provided for purposes of illustration of the embodiments only and are not intended to be limiting. The raw materials, reagents, chemicals, and other materials are presented as exemplary components or reagents, and various modifications may be made in view of the foregoing discussion within the scope of this disclosure. Unless otherwise specified in this disclosure, components, reagents, protocol, and other methods used in the system and the assays, as described in the Examples, are for the purpose of illustration only.

### Example 1

### Preparation of Shelf Stable Products Using UHT Process

A liquid (or slurry) composition was applied to a heat exchange system designed for aseptic high temperature short time (HTST) processing. The product was heated by the heat exchange system to a high temperature of about 147-149° C. under pressure and was held at that temperature for 15 seconds. Immediately after achieving the established minimum time at the established minimum temperature, the composition was subject to a cooling step where its temperature was quickly reduced to about 25-37° C. while the composition was still residing within the sterile zone of the system. While the sterilized and cooled product was still within the sterile zone, it was filled into a sterilized packaging container. The container may be pouches, cartons, or totes. In this example, the packaging container was pre-sterilized and was hermetically sealed. The liquid (or slurry) composition may be a liquid broth prepared from an animal source, such as poultry. Thus, the resultant product has special utility advantages in storage, shipping, and handling because once the product is sealed it may be stored at room temperature and shipped under room temperature. Also, because it is stored at room temperature at end-user's site, it turns into useable liquid state much faster than conventional frozen blocks.

The product may be stored at ambient temperature. Because the product has high percentage of solids, the water activity is very low. Thus, the product is not only sterile by itself inside the container, but it also provides little support for microbial growth in case the sterile container is breached and microorganisms find their way into the container. In this Example, the liquid composition had about 32% solids after being subject to the disclosed UHT process. It was tested for the presence of Aerobic Mesophiles, Aerobic Mesophiles, Aerobic Thermophiles, Anaerobic Thermophiles in a certified commercial testing lab after 12 months. The tests showed that the composition in the container were negative for Aerobic Mesophiles, Aerobic Mesophiles, Aerobic Thermophiles, Anaerobic Thermophiles after 12 months stored at room temperature (about 25 C.). The composition of this Example was certified to meet the criteria set forth by the National Canners Association for commercial sterility.

The color of the broth composition turned darker after being treated by the UHT process. The change in color was measured by using an instrument ColorFlex EZ manufactured by HunterLab. The pre-treatment broth composition had a color value of 32.3, as measured by ColorFlex EZ, and the post-treatment broth composition had a color value of 30. Smaller color value indicates darker color.

The presently disclosed processes may be applicable to various compositions and ingredients disclosed in U.S. Patent applications U.S. patent application Ser. Nos. 14/210,284, and 14/325,694, and PCT application Nos. PCT/US2015/027934, PCT/US2015/027978, and PCT/US2015/027986, all of which are hereby incorporated into this disclosure as if fully reproduced herein.

Changes may be made in the above methods and systems without departing from the scope hereof. It should thus be noted that the matter contained in the above description or shown in the accompanying drawings should be interpreted as illustrative and not in a limiting sense. The following claims are intended to cover generic and specific features described herein, as well as statements of the scope of the present method and system, which, as a matter of language, might be said to fall there between.

Although each of the embodiments described above has been illustrated with various components having particular respective orientations, it should be understood that the system and methods as described in the present disclosure may take on a variety of specific configurations with the various components being located in a variety of positions and mutual orientations and still remain within the spirit and scope of the present disclosure. Furthermore, suitable equivalents may be used in place of or in addition to the various components, the function and use of such substitute or additional components being held to be familiar to those skilled in the art and are therefore regarded as falling within the scope of the present disclosure. Therefore, the present examples are to be considered as illustrative and not restrictive, and the present disclosure is not to be limited to the details given herein but may be modified within the scope of the appended claims.

All references cited in this disclosure, including patents, patent applications, scientific papers and other publications, are hereby incorporated by reference into this application.

We claim:

1. A composition comprising one or more proteins from an animal source, wherein said composition comprises about 20% to about 80% (w/w) solids, and wherein said composition is in a liquid state and is pumpable at 25° C., said composition being shelf-stable for at least 12 months.

2. The composition of claim 1, wherein the animal source is poultry.

3. The composition of claim 1, wherein the composition comprises at least 50% (w/w) solids.

4. The composition of claim 1, wherein the composition comprises at least 70% (w/w) solids.

5. The composition of claim 1, wherein the composition comprises about 20% to about 80% (w/w) protein.

6. The composition of claim 1, wherein the composition has a dynamic viscosity of lower than 500 cP at 25° C.

7. The composition of claim 1, wherein the composition has water activity of less than 0.85.

8. A system for storing or transporting a composition, said system comprising a container and a shelf-stable composition prepared from an animal source, said shelf-stable composition comprising about 20-80% (w/w) solids, and said shelf-stable composition being contained in a container having a germ-free headspace, wherein said composition is shelf-stable for at least 12 months and wherein said composition is liquid and pumpable at 25° C.

9. The system of claim 8, wherein the germ-free headspace is at least one cubic centimeter by volume.

10. A process of preparing a shelf stable composition, comprising
(a) heating a starting material to a first temperature of between 90° C. and 205° C. and hold at said first temperature for a period of time between 1 and 120 seconds,
(b) cooling said heated material of step (a) to a second temperature of between 15° C. and 50° C., and
(c) collecting the cooled material from step (b) as said shelf stable composition.

11. The process of claim 10, further comprising a step of filling said shelf stable composition into a sterilized packaging container after step (b).

12. The process of claim 10, further comprising a step of treating the starting material with an anti-gelling enzyme prior to step (a).

13. The process of claim 10, wherein said first temperature is between 120° C. and 150° C., and said starting material is held at said first temperature for between 15 and 60 seconds.

14. The process of claim 10, wherein said second temperature is between 25° C. and 37° C.

15. The process of claim 10, wherein total number of live pathogen in said shelf stable composition obtained in step (c) is at least 95% lower than total number of live pathogen in said starting material in step (a).

16. The process of claim 15, wherein said pathogen is at least one member selected from the group consisting of bacterium, fungus, virus and combination thereof.

17. The process of claim 15, wherein said pathogen is at least one member selected from the group consisting of E. coli, Salmonella, Listeria, Clostridium botulinum, Campylobacter, Shigella, Yersinia, Arcobacter, Bacillus and combination thereof.

18. The process of claim 10, wherein the composition obtained in (c) is pumpable at 25° C.

19. The process of claim 10, wherein the composition obtained in (c) comprises at least 50% (w/w) solids.

20. The composition of claim 1, wherein the composition has a pH between 6.1 and 7.0.
